(19) United States
(12) Patent Application Publication
(10) Pub. No.: US 2026/0213301 A1
(43) Pub. Date: Jul. 23, 2026

(54) CELL BARRIER FOR A PRISMATIC BATTERY CELL

(71) Applicant: GM Global Technology Operations LLC, Detroit, MI (US)

(72) Inventors: Sunil Prasanth Suseelan, Rochester Hills, MI (US); Arun Kanwar, Windsor (CA)

(21) Appl. No.: 19/034,976

(22) Filed: Jan. 23, 2025

(51) Int. Cl. H01M 10/658; H01M 10/48; H01M 10/625; H01M 10/637; H01M 10/647; H01M 50/15; H01M 50/209; H01M 50/249; H01M 50/342

(52) U.S. Cl. CPC H01M 10/658; H01M 10/486; H01M 10/625; H01M 10/637; H01M 10/647; H01M 50/15; H01M 50/209; H01M 50/249; H01M 50/3425

(57) ABSTRACT

A cell barrier to prevent thermal runaway propagation (TRP) in a prismatic battery cell includes a fire-resistant paper having a top side and a bottom side. The cell barrier further includes a top hat with a vent feature. The top hat is attached to the bottom side of the fire-resistant paper. The cell barrier further includes a left-hand side plate and a right-hand side plate attached to the top side of the fire-resistant paper. The cell barrier further includes a flex thermal barrier attached to either of the left-hand side plate and the right-hand side plate. The top hat is disposed between the left-hand side plate and the right-hand side plate. The cell barrier is positioned adjacent to the prismatic battery cell.

### INTRODUCTION

The present disclosure relates to a cell barrier for a prismatic battery cell. More particularly, the present disclosure relates to a cell barrier for a high nickel prismatic battery cell to prevent thermal runaway propagation (TRP).

A rechargeable energy storage system (RESS), for example a prismatic battery, includes a plurality of prismatic battery cells. Each of the prismatic battery cells includes an anode and a cathode spaced apart by an electrically insulative separator material. The prismatic battery cells are placed next to one another typically in a case or enclosure to protect the prismatic battery cells from the ambient environment. The prismatic battery cells in the RESS may undergo an uncontrolled thermal event known as thermal runaway propagation (TRP). The prismatic battery cell undergoing TRP may cause a neighboring prismatic battery cell to also undergo an increase in temperature. Increasing the temperature over one or more of the prismatic battery cells may cause the RESS to undergo TRP.

One solution to prevent the RESS from undergoing TRP is to enclose the RESS in a protective barrier. While effective for managing TRP in the RESS, there is a need for a new and improved system and method for preventing TRP in each of the prismatic battery cells.

### SUMMARY

According to several aspects, a cell barrier to prevent thermal runaway propagation (TRP) in a prismatic battery cell is provided. The prismatic battery cell has a first surface, a second surface, and a top cap. The cell barrier includes a fire-resistant paper having a top side and a bottom side opposite the top side. The cell barrier further includes a top hat attached to the bottom side of the fire-resistant paper. The top hat includes a vent feature. The cell barrier further includes a left-hand side plate attached to the top side of the fire-resistant paper. The cell barrier further includes a right-hand side plate attached to the top side of the fire-resistant paper. The cell barrier further includes a flex thermal barrier attached to either of the left-hand side plate and the right-hand side plate. The top hat is disposed between the left-hand side plate and the right-hand side plate. The right-hand side plate is positioned adjacent the first surface of the prismatic battery cell. The left-hand side plate is positioned adjacent the second surface of the prismatic battery cell. The top hat is positioned adjacent the top cap of the prismatic battery cell.

In an additional aspect of the present disclosure, the fire-resistant paper further includes an adhesive. The adhesive adheres the bottom side of the fire-resistant paper to the top hat.

In another aspect of the present disclosure, the fire-resistant paper further includes an adhesive. The adhesive adheres the top side of the fire-resistant paper to the left-hand side plate.

In another aspect of the present disclosure, the fire-resistant paper further includes an adhesive. The adhesive adheres the top side of the fire-resistant paper to the right-hand side plate.

In another aspect of the present disclosure, the vent feature is defined by a perforated edge. The perforated edge is disposed on a top surface of the top hat and extends through a bottom surface of the top hat.

In another aspect of the present disclosure, the vent feature is a weakened material disposed on a top surface of the top hat and extends through a bottom surface of the top hat.

In another aspect of the present disclosure, the top hat further includes a thermistor cutout. The thermistor cutout is disposed on the top surface of the top hat and extends through the bottom surface of the top hat. The thermistor cutout is positioned between the vent feature and a top edge of the top hat.

In another aspect of the present disclosure, the top hat further includes a first cell terminal cutout. The first cell terminal cutout is disposed on the top surface of the top hat and extends through the bottom surface of the top hat. The first terminal cutout is nearing a top edge of the top hat and positioned between the vent feature and the top edge.

In another aspect of the present disclosure, the top hat further includes a first cell terminal cutout. The first cell terminal cutout is disposed on the top surface of the top hat and extends through the bottom surface of the top hat. The first terminal cutout is nearing a top edge of the top hat and positioned between the vent feature and the top edge.

In another aspect of the present disclosure, the top hat further includes a second cell terminal cutout. The second cell terminal cutout is disposed on the top surface of the top hat and extends through the bottom surface of the top hat. The second terminal cutout is nearing a bottom edge of the top hat and positioned between the vent feature and the bottom edge.

In another aspect of the present disclosure, the top hat, the left-hand side plate, and the right-hand side plate are composed of mica.

In another aspect of the present disclosure, the flex thermal barrier further includes an adhesive. The adhesive adheres the flex thermal barrier to either of the left-hand side plate and the right-hand side plate.

In another aspect of the present disclosure, the left-hand side plate matches the contour and size of the first surface of the prismatic battery cell, covering the first surface.

In another aspect of the present disclosure, the right-hand side plate matches the contour and size of the second surface of the prismatic cell, covering the second surface.

According to several aspects, a battery module for a prismatic battery is provided. The battery module includes a prismatic battery cell disposed within the battery module. The prismatic battery cell includes a top cap having an upper edge and a lower edge. The top cap includes a cell vent. The cell vent is disposed on the top cap. The top cap further includes a temperature sensor. The temperature sensor is positioned between the cell vent and the first cell terminal. The top cap further includes a first cell terminal. The first cell terminal is positioned between the upper edge and the temperature sensor. The top cap further includes a second cell terminal. The second cell terminal is positioned between the lower edge and the cell vent. The prismatic battery cell further includes a first surface. The first surface is positioned adjacent to the top cap. The prismatic battery cell further includes a second surface. The second surface is positioned adjacent to the top cap. The battery module further includes a cell barrier attached to the prismatic battery cell. The cell barrier includes a fire-resistant paper having a top side and a bottom side opposite the top side. The cell barrier further includes a top hat attached to the bottom side of the fire-resistant paper. The top hat includes a vent feature. The vent feature extends from a top surface of the top hat to a bottom surface opposite the top surface. The top hat further includes a thermistor cutout. The thermistor cutout extends from the top surface to the bottom surface. The top hat further includes a first cell terminal cutout. The first cell terminal cutout extends from the top surface to the bottom surface. The top hat further includes a second cell terminal cutout. The second cell terminal cutout extends from the top surface to the bottom surface. The cell barrier further includes a left-hand side plate attached to the top side of the fire-resistant paper. The cell barrier further includes a right-hand side plate attached to the top side of the fire-resistant paper. The cell barrier further includes a flex thermal barrier attached to either of the left-hand side plate and the right-hand side plate. The top hat is disposed between the left-hand side plate and the right-hand side plate. The left-hand side plate is adjacent to the first surface of the prismatic battery cell. The right-hand side plate is adjacent to the second surface of the prismatic battery cell. The top hat is adjacent to the top cap of the prismatic battery cell.

In another aspect of the present disclosure, the cell vent of the top cap is aligned with the vent feature of the cell barrier.

In another aspect of the present disclosure, the temperature sensor of the top cap is aligned with the thermistor cutout of the cell barrier.

In another aspect of the present disclosure, the first cell terminal of the top cap is aligned with the first cell terminal cutout of the cell barrier.

In another aspect of the present disclosure, the second cell terminal of the top cap is aligned with the second cell terminal cutout of the cell barrier.

In another aspect of the present disclosure, the prismatic battery cell is a high nickel prismatic battery cell.

According to several aspects, a method for attaching a cell barrier to a prismatic battery cell to prevent thermal runaway propagation (TRP) in the prismatic battery cell is provided. The method includes assembling a cell barrier. The cell barrier includes a fire-resistant paper having a top side and a bottom side opposite the top side. The cell barrier further includes a top hat attached to the bottom side of the fire-resistant paper. The top hat includes a vent feature. The vent feature extends from a top surface of the top hat to a bottom surface opposite the top surface. The top hat further includes a thermistor cutout. The thermistor cutout extends from the top surface to the bottom surface. The top hat further includes a first cell terminal cutout. The first cell terminal cutout extends from the top surface to the bottom surface. The top hat further includes a second cell terminal cutout. The second cell terminal cutout extends from the top surface to the bottom surface. The cell barrier further includes a left-hand side plate attached to the top side of the fire-resistant paper. The cell barrier further includes a right-hand side plate attached to the top side of the fire-resistant paper. The cell barrier further includes a flex thermal barrier attached to either of the left-hand side plate and the right-hand side plate. The top hat is disposed between the left-hand side plate and the right-hand side plate. The method further includes attaching a plurality of suction cups to the cell barrier. The method further includes aligning the cell barrier to the prismatic battery cell. The prismatic battery cell includes a first surface. The first surface is aligned to the left-hand side plate. The prismatic battery cell further includes a second surface. The second surface is aligned to the right-hand side. The prismatic battery cell further includes a top cap. The top cap includes a cell vent. The cell vent is aligned to the vent feature of the top hat. The top cap further includes a temperature sensor. The temperature sensor is aligned to the thermistor cutout of the top hat. The top cap further includes a first cell terminal. The first cell terminal is aligned to the first terminal cutout of the top hat. The top cap further includes a second cell terminal. The second cell terminal is aligned to the second terminal cutout of the top hat. The method further includes maneuvering the left-hand side plate towards the first surface of the prismatic battery cell. The method further includes maneuvering the right-hand side plate towards the second surface of the prismatic battery cell. The method further includes removing the suction cups from the cell barrier to attach the cell barrier to the prismatic battery cell.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 illustrates a vehicle including a battery pack with a cell barrier attached to a plurality of prismatic battery cells according to an exemplary embodiment.

FIG. 2 is a cross-section view of the cell barrier attached to the plurality of prismatic battery cells according to an exemplary embodiment.

FIG. 3 is a top view of the cell barrier according to an exemplary embodiment.

FIG. 4 is a side view of the cell barrier attached to the plurality of prismatic battery cells according to an exemplary embodiment.

FIG. 5 is a flowchart for a method attaching the cell barrier to each of the plurality of prismatic battery cells according to an exemplary embodiment.

FIG. 6 illustrates the method for attaching the cell barrier to each of the plurality of prismatic battery cells according to an exemplary embodiment.

### DETAILED DESCRIPTION

The following description is merely exemplary in nature and is not intended to limit the present disclosure, application, or uses.

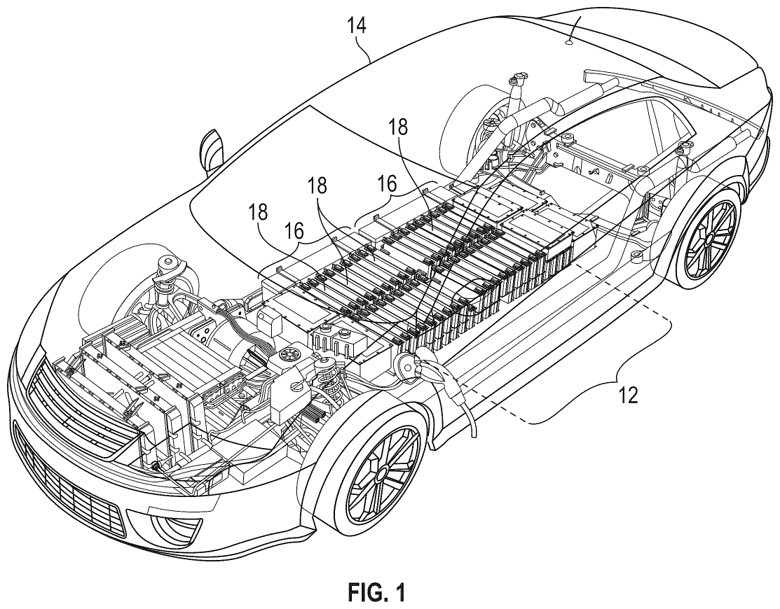

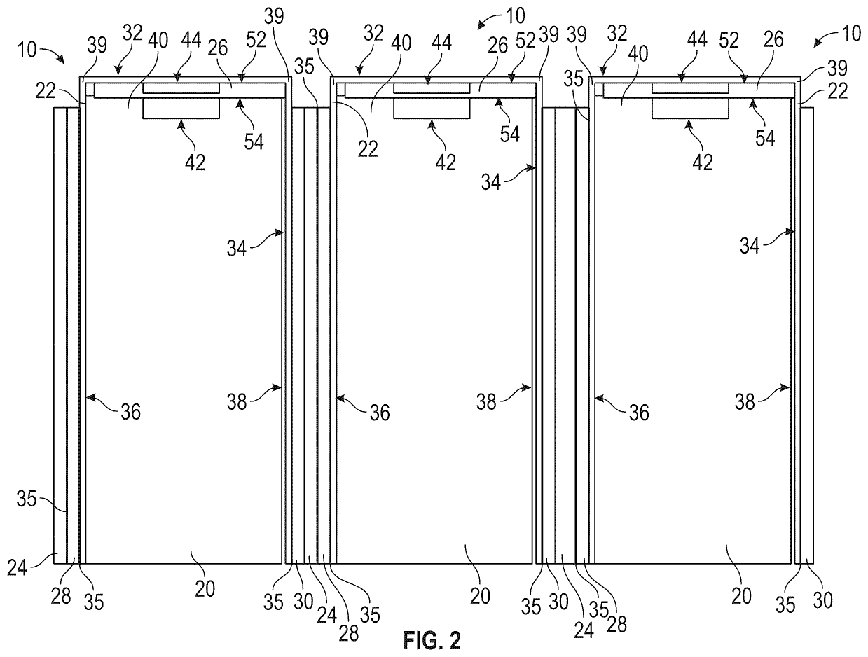

Referring to FIG. 1, a cell barrier 10 (shown in FIG. 2) for a battery pack 12 disposed in a vehicle 14 is illustrated. The battery pack 12 includes a plurality of battery modules 16 that are electronically connected to one another. Each of the battery modules 16 includes a housing 18 that encloses a plurality of prismatic battery cells 20 (shown in FIG. 2). It is to be appreciated that FIG. 1 is merely exemplary in nature, and the plurality of battery modules 16 are not limited to being employed as a battery for the vehicle 14. Indeed, the battery modules 16 may be used in a variety of other electromobility and stationary applications. It is also to be appreciated that although the vehicle 14 is illustrated as a sedan, the vehicle 14 may be any type of vehicle such as, but not limited to, a truck, sport utility vehicle, van, or motor home.

Referring to FIG. 2, a cross-section view of the cell barrier 10 attached to each of the plurality of prismatic battery cells 20 is illustrated. Attaching the cell barrier 10 to the plurality of prismatic battery cells 20 prevents thermal runaway propagation (TRP). The cell barrier 10 includes a fire-resistant paper 22, a flex thermal barrier 24, a top hat 26, a left-hand side plate 28, and a right-hand side plate 30.

The fire-resistant paper 22 may be, and is not limited to, mica tape or ceramic paper. The fire-resistant paper 22 adheres to the top hat 26, the left-hand side plate 28, and the right-hand side plate 30. The fire-resistant paper 22 includes a top side 32 and a bottom side 34, the top side 32 is opposite of the bottom side 34. An adhesive 35 is applied to the top side 32 of the fire-resistant paper 22, adhering the top hat 26 to the top side 32. The adhesive 35 is applied to the bottom side 34 of the fire-resistant paper 22, adhering the left-hand side plate 28 and the right-hand side plate 30 to the bottom side 34.

The flex thermal barrier 24 may be, but is not limited to, an aerogel mat. The adhesive 35 is applied to the flex thermal barrier 24, adhering the flex thermal barrier 24 to either of the left-hand side plate 28 or the right-hand side plate 30. The top hat 26, the left-hand side plate 28, and the right-hand side plate 30 will be described in further detail below.

The plurality of prismatic battery cells 20 includes a first surface 36, a second surface 38, and a top cap 40. It should be appreciated that each of the prismatic battery cells 20 is identical, and therefore, only one of the prismatic battery cells 20 will be described herein. The left-hand side plate 28 is adjacent to the first surface 36 of the prismatic battery cell 20. The right-hand side plate 30 is adjacent to the second surface 38 of the prismatic battery cell 20. The top hat 26 is adjacent to the top cap 40 of the prismatic battery cell 20. The top cap 40 includes a temperature sensor (not shown), a cell vent 42, a first cell terminal (not shown), and a second cell terminal (not shown).

The temperature sensor (not shown) is used to sense and monitor the temperature of the prismatic battery cell 20. The temperature sensor may be, but is not limited to, a thermistor, a thermocouple, an infrared (IR) sensor, a resistant temperature detector (RTD), a semiconductor-based integrated circuit, etc. When the temperature sensor detects an abnormal rise of temperature, which increases the internal pressure of the prismatic battery cell 20, the cell vent 42 activates to release the built-up pressure and gas. This aids in preventing the cell from undergoing TRP.

The first cell terminal (not shown) and the second cell terminal (not shown) are points of the prismatic battery cell 20 where the battery modules 16 (shown in FIG. 1) connect to an external circuit. The first cell terminal is a positive terminal and the second cell terminal is a negative terminal. The first cell terminal and the second cell terminal may also be used to monitor a voltage and the temperature of the prismatic battery cell 20.

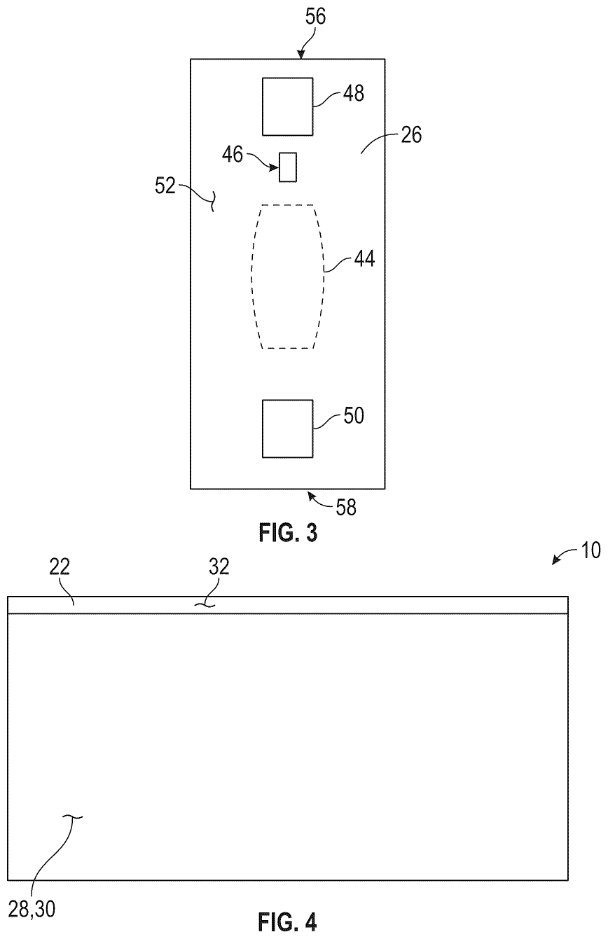

Referring to FIG. 3, a top view of the top hat 26 is illustrated. The top hat 26 may be, but is not limited to, mica. The top hat 26 includes a vent feature 44, a thermistor cutout 46, a first cell terminal cutout 48, and a second cell terminal cutout 50. The vent feature 44 is disposed on a top surface 52 of the top hat 26 and extends to a bottom surface 54 (shown in FIG. 2) of the top hat 26, the bottom surface 54 is opposite the top surface 52. The vent feature 44 may defined a perforated edge. The perforated edge weakens a contour of the vent feature 44 causing the vent feature 44 to detach from the top hat 26 while under an application of pressure. A pressure is applied to the vent feature 44 when the internal pressure of the prismatic battery cell 20 increases, activating the cell vent 42 to release the built-up pressure and gas. Alternatively, the vent feature 44 may be composed of a weakened material, such as, but not limited to, a thin layer of mica. The weakened material of the vent feature 44 causes the vent feature 44 to detach from the top hat 26 while under the application of pressure from the cell vent 42.

The thermistor cutout 46 is disposed on the top surface 52 of the top hat 26 and extends through the bottom surface 54 (shown in FIG. 2) of the top hat 26. The thermistor cutout 46 is positioned between the vent feature 44 and the first cell terminal cutout 48. The first cell terminal cutout 48 is disposed on the top surface 52 of the top hat 26 and extends through the bottom surface 54 of the top hat 26. The first cell terminal cutout 48 nears a top edge 56 of the top hat 26 and is positioned between the top edge 56 and the thermistor cutout 46. The second cell terminal cutout 50 is disposed on the top surface 52 of the top hat 26 and extends through the bottom surface 54 of the top hat 26. The second cell terminal cutout 50 nears a bottom edge 58 of the top hat 26 and is positioned between the bottom edge 58 and the vent feature 44.

Referring to FIG. 4, a side view of the cell barrier 10 attached to the prismatic battery cell 20 is illustrated. It should be appreciated that the first surface 36 and the second surface 38 of the prismatic battery cell 20 are equal but opposite. In addition, the left-hand side plate 28 and the right-hand side plate 30 have identical features but are positioned on different surfaces of the prismatic battery cell 20. The left-hand side plate 28 and the right-hand side plate 30 may be, but are not limited to, mica. The left-hand side plate 28 is attached to the first surface 36 of the prismatic battery cell 20. The left-hand side plate 28 matches the contour and size of the first surface 36, covering the entire first surface 36. The right-hand side plate 30 is attached to the second surface 38 of the prismatic battery cell 20. The right-hand side plate 30 matches the contour and size of the second surface 38, covering the entire second surface 38. The flex thermal barrier 24 may be attached to either the left-hand side plate 28 or the right-hand side plate 30. The flex thermal barrier 24 matches the contour and size of the left-hand side plate 28 and the right-hand side plate 30.

The top side 32 of the fire-resistant paper 22 is adhered to the left-hand side plate 28 and the right-hand side plate 30. The fire-resistant paper 22 matches a width of the left-hand side plate 28 and the right-hand side plate 30. The fire-resistant paper 22 has a length that extends from the left-hand side plate 28 to the right-hand side plate 30, covering corners 39 (shown in FIG. 2) of the prismatic battery cell 20. The corners 39 of the prismatic battery cell 20 are positioned between the top hat 26 and the left-hand side plate 28 and positioned between the top hat 26 and the right-hand side plate 30. Thus, the cell barrier 10 wraps around the prismatic battery cell 20.

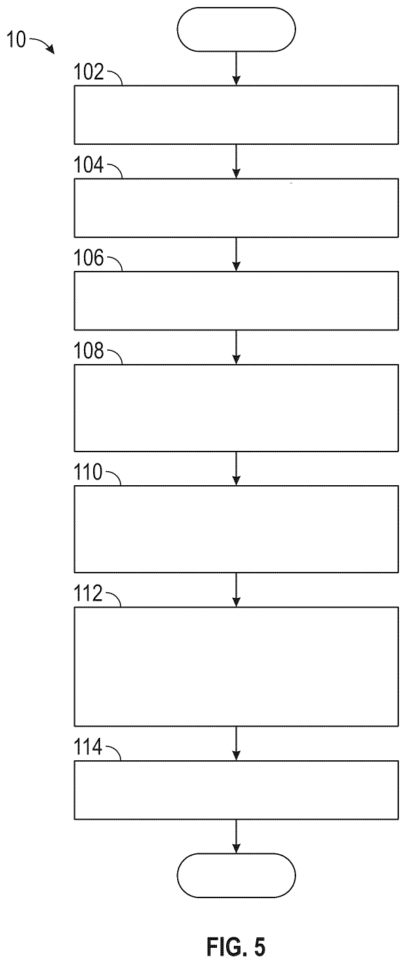

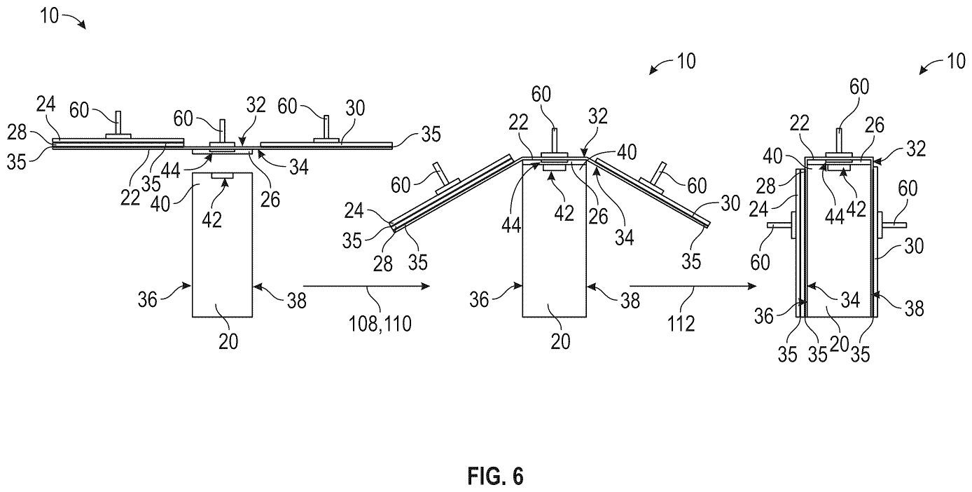

Referring to FIGS. 5 and 6, FIG. 5 is a flow chart for a method 100 of attaching the cell barrier 10 to each of the plurality of prismatic battery cells 20 and FIG. 6 is a diagram illustrating the method 100. The method 100 begins with step 102. At step 102, the cell barrier 10 is assembled. The cell barrier 10 includes the fire-resistant paper 22, the top hat 26, the left-hand side plate 28, and the right-hand side plate 30. The cell barrier 10 is assembled by applying the adhesive 35 to the fire-resistant paper 22. The bottom side 34 of the fire-resistant paper 22 is adhered to the top hat 26. The top side 32 of the fire-resistant paper 22 is adhered to the left-hand side plate 28 and to the right-hand side plate 30. The top hat 26 is positioned between the left-hand side plate 28 and the right-hand side plate 30. The cell barrier 10 further includes the flex thermal barrier 24 which is adhered to either the left-hand side plate 28 or the right-hand side plate 30. The method 100 proceeds to step 104.

At step 104, a plurality of suction cups 60 are attached to the cell barrier 10. The plurality of suction cups 60 may attach to the flex thermal barrier 24, the fire-resistant paper 22, and the left-hand side plate 28 or the right-hand side plate 30. The method 100 proceeds to step 106.

At step 106, the top hat 26 is aligned to the top cap 40 of prismatic battery cell 20. The vent feature 44 of the top hat 26 aligns with the cell vent 42 of the top cap 40. The thermistor cutout 46 (shown in FIG. 3) aligns with the temperature sensor (not shown) of the top cap 40. The first cell terminal cutout 48 (shown in FIG. 3) aligns with the first cell terminal (not shown) of the top cap 40. The second cell terminal cutout 50 (shown in FIG. 3) aligns with the second cell terminal (not shown) of the top cap 40. The method 100 proceeds to step 108.

At step 108, the left-hand side plate 28 is maneuvered towards the first surface 36 of the prismatic battery cell 20. The method 100 proceeds to step 110. At step 110, the right-hand side plate 30 is maneuvered towards the second surface 38 of the prismatic battery cell 20. The method 100 proceeds to step 112. At step 112, the left-hand side plate 28 is in contact with the first surface 36 and the right-hand side plate 30 is in contact with the second surface 38. The left-hand side plate 28 matches a contour and size of the first surface 36, covering the entire first surface 36. The right-hand side plate 30 matches a contour and size of the second surface 38, covering the entire second surface 38. The method 100 proceeds to step 114. At step 114, the plurality of suction cups 60 are removed from the cell barrier 10, attaching the cell barrier 10 to the prismatic battery cell 20.

The cell barrier 10 and the method 100 to attach the cell barrier 10 to the prismatic battery cell 20 includes many advantages. The cell barrier 10 creates protection from TRP for each prismatic battery cell 20 of the battery module 16. Protecting each prismatic battery cell 20 from TRP creates a high level of TRP protection for the entire battery pack 12. The cell barrier 10 limits the risk of one of the plurality of prismatic battery cells 20, which is undergoing TRP, from causing a neighboring prismatic battery cell 20 from undergoing TRP. The method to attach the cell barrier 10 to the plurality of prismatic battery cells 20 allows for a lower manufacturing cycle time.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A cell barrier to prevent thermal runaway propagation (TRP) in a prismatic battery cell, the prismatic battery cell having a first surface, a second surface, and a top cap, the cell barrier comprising:
a fire-resistant paper having a top side and a bottom side opposite the top side;
a top hat attached to the bottom side of the fire-resistant paper, the top hat including a vent feature;
a left-hand side plate attached to the top side of the fire-resistant paper;
a right-hand side plate attached to the top side of the fire-resistant paper; and
a flex thermal barrier attached to either of the left-hand side plate and the right-hand side plate,
wherein the top hat is disposed between the left-hand side plate and the right-hand side plate, and
wherein the right-hand side plate is positioned adjacent the first surface of the prismatic battery cell, the left-hand side plate is positioned adjacent the second surface of the prismatic battery cell, and the top hat is positioned adjacent the top cap of the prismatic battery cell.

2. The cell barrier of claim 1, wherein the fire-resistant paper further comprises an adhesive wherein the adhesive adheres the bottom side of the fire-resistant paper to the top hat.

3. The cell barrier of claim 1, wherein the fire-resistant paper further comprises an adhesive wherein the adhesive adheres the top side of the fire-resistant paper to the left-hand side plate.

4. The cell barrier of claim 1, wherein the fire-resistant paper further comprises an adhesive wherein the adhesive adheres the top side of the fire-resistant paper to the right-hand side plate.

5. The cell barrier of claim 1, wherein the vent feature is defined by a perforated edge and wherein the perforated edge is disposed on a top surface of the top hat and extends through a bottom surface of the top hat.

6. The cell barrier of claim 1, wherein the vent feature is a weakened material disposed on a top surface of the top hat and extends through a bottom surface of the top hat.

7. The cell barrier of claim 1, wherein the top hat further comprises a thermistor cutout, wherein the thermistor cutout is disposed on a top surface of the top hat and extends through a bottom surface of the top hat, and wherein the thermistor cutout is positioned between the vent feature and a top edge of the top hat.

8. The cell barrier of claim 1, wherein the top hat further comprises a first cell terminal cutout, wherein the first cell terminal cutout is disposed on a top surface of the top hat and extends through a bottom surface of the top hat, and wherein the first cell terminal cutout is nearing a top edge of the top hat and positioned between the vent feature and the top edge.

9. The cell barrier of claim 1, wherein the top hat further comprises a second cell terminal cutout, wherein the second cell terminal cutout is disposed on a top surface of the top hat and extends through a bottom surface of the top hat, and wherein the second cell terminal cutout is nearing a bottom edge of the top hat and positioned between the vent feature and the bottom edge.

10. The cell barrier of claim 1, wherein the top hat, the left-hand side plate, and the right-hand side plate are composed of mica.

11. The cell barrier of claim 1, wherein the flex thermal barrier further comprises an adhesive, wherein the adhesive adheres the flex thermal barrier to either of the left-hand side plate and the right-hand side plate.

12. The cell barrier of claim 1, wherein the left-hand side plate matches a contour and size of the first surface of the prismatic battery cell, covering the first surface.

13. The cell barrier of claim 1, wherein the right-hand side plate matches a contour and size of the second surface of the prismatic battery cell, covering the second surface.

14. A battery module for a prismatic battery, the battery module comprising:
a prismatic battery cell disposed within the battery module, the prismatic battery cell including:
a top cap having an upper edge and a lower edge, the top cap including:
a cell vent, wherein the cell vent is disposed on the top cap;
a temperature sensor, wherein the temperature sensor is positioned between the cell vent and a first cell terminal;
the first cell terminal, wherein the first cell terminal is positioned between the upper edge and the temperature sensor; and
a second cell terminal, wherein the second cell terminal is positioned between the lower edge and the cell vent;
a first surface, wherein the first surface is positioned adjacent to the top cap; and
a second surface, wherein the second surface is positioned adjacent to the top cap; and
a cell barrier attached to the prismatic battery cell, the cell barrier including:
a fire-resistant paper having a top side and a bottom side opposite the top side;
a top hat attached to the bottom side of the fire-resistant paper, the top hat including:
a vent feature, wherein the vent feature extends from a top surface of the top hat to a bottom surface opposite the top surface;
a thermistor cutout, wherein the thermistor cutout extends from the top surface to the bottom surface;
a first cell terminal cutout, wherein the first cell terminal cutout extends from the top surface to the bottom surface; and
a second cell terminal cutout, wherein the second cell terminal cutout extends from the top surface to the bottom surface;
a left-hand side plate attached to the top side of the fire-resistant paper;
a right-hand side plate attached to the top side of the fire-resistant paper; and
a flex thermal barrier attached to either of the left-hand side plate and the right-hand side plate,
wherein the top hat is disposed between the left-hand side plate and the right-hand side plate, and
wherein the left-hand side plate is adjacent to the first surface of the prismatic battery cell, the right-hand side plate is adjacent to the second surface of the prismatic battery cell, and the top hat is adjacent to the top cap of the prismatic battery cell.

15. The battery module of claim 14, wherein the cell vent of the top cap is aligned with the vent feature of the cell barrier.

16. The battery module of claim 14, wherein the temperature sensor of the top cap is aligned with the thermistor cutout of the cell barrier.

17. The battery module of claim 14, wherein the first cell terminal of the top cap is aligned with the first cell terminal cutout of the cell barrier.

18. The battery module of claim 14, wherein the second cell terminal of the top cap is aligned with the second cell terminal cutout of the cell barrier.

19. The battery module of claim 14, wherein the prismatic battery cell is a high nickel prismatic battery cell.

20. A method for attaching a cell barrier to a prismatic battery cell to prevent thermal runaway propagation (TRP) in the prismatic battery cell, the method comprising:
assembling the cell barrier, the cell barrier including:
a fire-resistant paper having a top side and a bottom side opposite the top side;
a top hat attached to the bottom side of the fire-resistant paper, the top hat including:
a vent feature, wherein the vent feature extends from a top surface of the top hat to a bottom surface opposite the top surface;
a thermistor cutout, wherein the thermistor cutout extends from the top surface to the bottom surface;
a first cell terminal cutout, wherein the first cell terminal cutout extends from the top surface to the bottom surface; and
a second cell terminal cutout, wherein the second cell terminal cutout extends from the top surface to the bottom surface;
a left-hand side plate attached to the top side of the fire-resistant paper;
a right-hand side plate attached to the top side of the fire-resistant paper;
a flex thermal barrier attached to either of the left-hand side plate and the right-hand side plate, and
wherein the top hat is disposed between the left-hand side plate and the right-hand side plate,
attaching a plurality of suction cups to the cell barrier;
aligning the cell barrier to the prismatic battery cell, the prismatic battery cell including:
a first surface, wherein the first surface is aligned to the left-hand side plate;
a second surface, wherein the second surface is aligned to the right-hand side; and
a top cap including:
a cell vent, wherein the cell vent is aligned to the vent feature of the top hat;
a temperature sensor, wherein the temperature sensor is aligned to the thermistor cutout of the top hat;
a first cell terminal, wherein the first cell terminal is aligned to the first terminal cutout of the top hat; and
a second cell terminal, wherein the second cell terminal is aligned to the second terminal cutout of the top hat;
maneuvering the left-hand side plate towards the first surface of the prismatic battery cell;
maneuvering the right-hand side plate towards the second surface of the prismatic battery cell; and
removing the suction cups from the cell barrier to attach the cell barrier to the prismatic battery cell.
